(19) United States
(12) Patent Application Publication
(10) Pub. No.: US 2006/0176131 A1
(43) Pub. Date: Aug. 10, 2006

(54) RF-resonator tuning

(75) Inventor: Bernhard Junginger, Leonberg (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/305,159

(22) Filed: Dec. 19, 2005

(30) Foreign Application Priority Data
Feb. 9, 2005 (EP) 05290294.7

(51) Int. Cl. H01P 7/06

(52) U.S. Cl. 333/227

(57) ABSTRACT

A RF-resonator (1) comprises a resonator body (2) with at least one resonant cavity (3). A conductive sheet material forms a surface area of the resonant cavity (3), the conductive sheet material being deformable by application of a mechanical force for tuning the resonator to a target frequency. A method for tuning the RF-resonator, comprising the following steps: measuring the resonance frequency of the resonant cavity (3), and deforming the conductive sheet material by applying an increasing mechanical force to the conductive sheet material until the target frequency of the resonant cavity (3) is reached.

The invention is based on a priority application EP 05 290 294.7 which is hereby incorporated by reference.

### FIELD OF THE INVENTION

The invention relates to a RF-resonator comprising a resonator body with at least one resonant cavity and a method for tuning the same.

### BACKGROUND OF THE INVENTION

Electronic systems which use extremely high radio frequencies (RF), such as optical data transmission equipment or millimeter wave radio, either point-to-point or point to multipoint, as well as telematic equipment and subscriber access systems require resonators and filters with a precisely adjusted resonator frequency.

To assure tunability of manufactured raw filter components to a desired exact target frequency, the state of the art makes use of special microwave tuning components (e.g. metallic screws/dielectric rods). These components are commonly available on the market, but expensive. Their price is caused by gold-plating, choice of specialized materials, labor cost for mounting the screw/nut/rod subassembly as well as very expensive means to assure good and constant long-term (30 years) contact from screw to nut all around the screw's circumference, e.g. by introduction of individual spring-loaded slits in the screw. Typical maximum operating frequencies specified are around 12 GHz, with some exceptions up to 18 GHz.

Going to higher and higher frequencies, standard tuning components introduce more and more problems due to their increasing relative size to wavelength ratio. On the other hand, screw manufacturing costs increase dramatically when trying to keep screw diameter small compared to free-space wavelength (e.g. 3.5 mm for 85 GHz) with manufacturing tolerances scaled down as well. The state-of-the-art components become more and more fragile to handle as well.

### OBJECT OF THE INVENTION

It is the object of the invention to provide a RF-resonator and a method for tuning the RF-resonator to a target frequency in a straightforward, repeatable and cost-effective way.

### SHORT DESCRIPTION OF THE INVENTION

This object is achieved by a conductive sheet material forming a surface area of the resonant cavity, the conductive sheet material being deformable by application of a mechanical force for tuning the resonator to a target frequency.

The inventive RF-resonator separates the functionalities of ‘forced mechanical movement’ and ‘electromagnetic field manipulation’ which are traditionally combined in one component. In such a way any, even minor, gaps in the resonator are avoided as would exist between threaded parts. By applying a mechanical force on the conductive sheet material, an elastic or inelastic deformation of the sheet material is generated which changes the electromagnetic field inside the cavity in order to compensate for manufacturing tolerances of the cavity.

In a preferred embodiment, the conductive sheet material is a metal foil. Metal foils are inexpensive materials which can easily be deformed by applying a mechanic force.

In a preferred embodiment, a face of the resonator body is covered by the conductive sheet material. In this way, the surface area of the resonant cavity is covered and at the same time a sufficient amount of space is provided for fixing the sheet material on the resonator body.

In a further preferred embodiment, the conductive sheet material is fixed on the resonator body by a cover mounted on the resonator body. It is extremely important that even minor gaps in the resonator cavity are avoided. As the conductive sheet material forms part of the cavity surface, it is also important to protect it from external forces leading to unwanted deformations causing a change in the target frequency of the resonator.

In a further embodiment, threaded holes are formed in the cover and the resonator body for mounting the cover on the resonator body. The cover can be fixed to the resonator body by inserting screws in the holes, such that unwanted deformations of the sheet material are avoided. Of course, the holes are positioned such that they do not extend to the cavity.

In a highly preferred embodiment the cover comprises a tuning opening for deformation of the conductive sheet material. In the case of a non-elastic deformation, a tool can be inserted into the opening for deforming the sheet material and the tuning opening can be closed afterwards. In the case of an elastic deformation, a tool may be inserted permanently in the tuning opening for maintaining a constant pressure on the sheet material, or e.g. a temperature-dependent pressure to compensate for (or cause a desired) temperature drift in the resonator.

In a further preferred embodiment the cover and the resonator body are made of the same material. In this way, relative thermal movements between the cover and the resonator body are avoided which could cause e.g. sudden phase jumps.

In a further embodiment the resonator body comprises at least two centering pins. The centering pins are necessary to assure that the tuning opening is correctly positioned for tuning the resonator. For a cylindrical cavity, for example, the tuning opening can but need not be positioned along the center axis of the cylinder, determined by the desired tuning sensitivity and the mode of the electromagnetic resonance. Depending on the design, the resonance frequency may increase or decrease with increasing tuning force.

In a preferred embodiment the resonator body is made of a die cast part. Using a die cast part instead of a milled block for forming the resonator body, manufacturing costs are reduced. Preferably, the cover is also made of a die cast part.

The invention is also realized in a method for tuning a RF-resonator as described above, comprising the following steps: measuring the resonance frequency of the resonant cavity, and deforming the conductive sheet material by applying an increasing mechanical force to the conductive sheet material until the target frequency of the resonant cavity is reached. In the case of a non-elastic (irreversible) deformation of the sheet material, the mechanical force must not exceed the value necessary for reaching the target frequency. In the case of an elastic deformation, it is possible to exceed this force value and subsequently decrease the mechanical force for adjusting the resonator frequency to the target frequency.

Further advantages can be extracted from the description and the enclosed drawing. The features mentioned above and below can be used in accordance with the invention either individually or collectively in any combination. The embodiments mentioned are not to be understood as exhaustive enumeration but rather have exemplary character for the description of the invention.

### BRIEF DESCRIPTION OF THE DRAWINGS

The invention is shown in the drawing.

FIG. 1a shows a resonator body with a resonant cavity being part of an embodiment of the inventive RF-resonator in a perspective view,

FIG. 1b shows the resonator body of FIG. 1a covered by a thin metal foil, and

FIG. 1c shows a cover mounted on the resonator body of FIG. 1b, the cover having a tuning opening for deforming the metal foil.

### DETAILED DESCRIPTION OF THE INVENTION

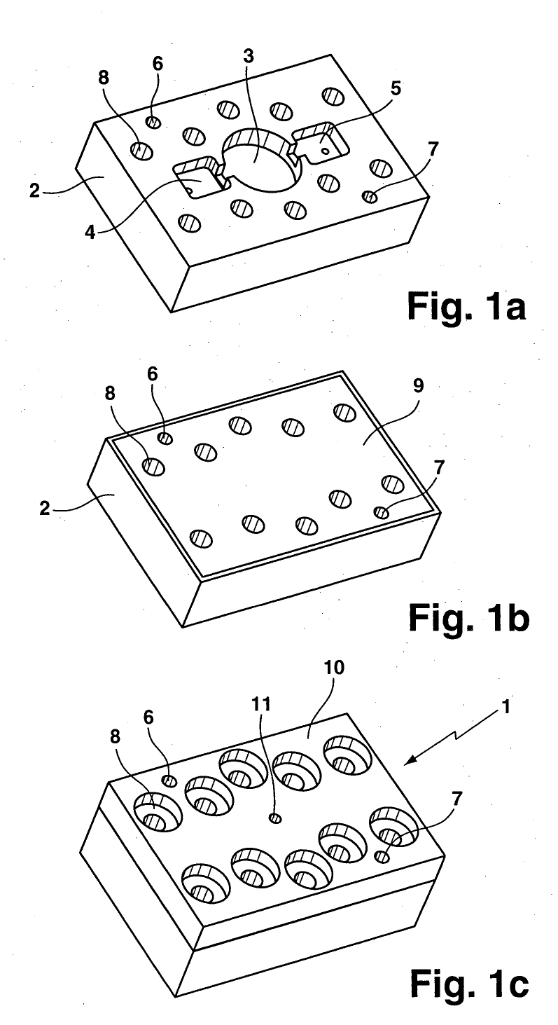

In FIG. 1a to FIG. 1c three steps of assembling a prototype RF-resonator 1 are shown. With reference to FIG. 1a, a rectangular milled block forms a resonator body 2 which contains a centered cylindrical hole as a resonant cavity 3. To the left and to the right of the cavity 3, two rectangular holes 4, 5 are formed in the resonator body 2 for receiving a first and a second connector (not shown) being inserted through two pinholes from the bottom of the resonator body 2. Two centering pinholes 6, 7 and ten threaded holes 8 are formed on the resonator body 2 as well.

With reference now to FIG. 1b, the top face of the resonator body 2 of FIG. 1a is covered with a thin metal foil 9 which has holes at the positions of the pinholes 6, 7 and the threaded holes 8. The metal foil 9 covers the resonant cavity 3 and is fixed by mounting a thick cover 10 on top of the resonator body 2, as shown in FIG. 1c. The two pinholes 6, 7 and ten threaded holes 8 formed in the resonator body 2 are continued through the cover 3. Thus, the cover 3 may be fixed to the resonator body 2 by inserting mounting screws into the threaded holes 8. In such a way, the metal foil 9 is firmly fixed between the resonator body 2 and the cover 3, such that unwanted deformations of the metal foil 9 leading to changes in the center frequency of the resonant cavity 3 are avoided.

A tuning opening 11 is provided in the center of the cover 10. The tuning opening 11 is centered by two centering pins (not shown) being inserted into the two pinholes 6, 7. The tuning opening 11 should be positioned such that a reasonable force/movement to frequency dependency of the resonance is achieved. This depends on the mode of the electromagnetic field in the cavity. Shown in the example is a tuning opening exactly on the center axis of the cylindrical cavity 3 for having a small influence on the electromagnetic field inside of the cavity 3 for the mode chosen, just sufficient to compensate for manufacturing tolerances.

Tuning of the RF-resonator 1 is typically performed by tool insertion in the minor tuning opening 11 of the cover 3 with increasing force until a sufficient non-elastic deformation of the metal foil 9 is reached so that the desired center frequency of the RF-resonator 1 is attained. During this process, the frequency of the resonant cavity 3 has to be observed. Alternatively, it is possible to use an elastically deformable foil and to fix the tool inside of the tuning opening when the target frequency is reached.

In summary, the prototype RF-resonator 1 can be easily manufactured and hence production costs are minimized. There are no ‘exotic components’ being used for the frequency tuning of the RF-resonator 1, a small number of parts is needed, and all parts (resonator body, cover, sheet material) can be manufactured from the same material to avoid relative thermal movements (causing e.g. sudden phase jumps). The RF-resonator 1 is also suitable for high-volume mass production, especially if the milled block forming the resonator body 2 is replaced with a die cast part. Screws may also be replaced by a suitable soldering process. Furthermore, no precision parts except the resonator cavity itself are needed.

The performance of the RF-resonator 1 has been verified with high Q working design at 85 GHz, but a much higher practical frequency limit beyond 200 GHz is expected. Furthermore, long-term stability of the RF-resonator 1 is expected to be superior to traditional resonator design, especially concerning robustness in vibrating environments.

1. RF-resonator, comprising: a resonator body with at least one resonant cavity, and a conductive sheet material forming a surface area of the resonant cavity, wherein the conductive sheet material is non-elastically deformable by application of a mechanical force for tuning the RF-resonator to a target frequency.

2. RF-resonator according to claim 1, wherein the conductive sheet material is a metal foil.

3. RF-resonator according to claim 1, wherein a face of the resonator body is covered by the conductive sheet material.

4. RF-resonator according to claim 3, wherein the conductive sheet material is fixed to the resonator body by a cover mounted on the resonator body.

5. RF-resonator according to claim 3, wherein threaded holes are formed in the cover and the resonator body for mounting the cover on the resonator body.

6. RF-resonator according to claim 3, wherein the cover comprises a tuning opening for deformation of the conductive sheet material.

7. RF-resonator according to claim 6, wherein the cover comprises at least two centering pins.

8. RF-resonator according to claim 3, wherein the cover and the resonator body are made of the same material.

9. RF-resonator according to claim 1, wherein the resonator body is made of a die cast part.

10. Method for tuning a RF-resonator comprising: a resonator body with at least one resonant cavity, and a conductive sheet material forming a surface area of the resonant cavity, wherein the conductive sheet material is non-elastically deformable by application of a mechanical force for tuning the RF-resonator to a target frequency, said method comprising the following steps of: measuring the resonance frequency of the resonant cavity, and deforming the conductive sheet material non-elastically by applying an increasing mechanical force to the conductive sheet material until the target frequency of the resonant cavity is reached.
